(19) United States
(12) Patent Application Publication
(10) Pub. No.: US 2011/0082812 A1
(43) Pub. Date: Apr. 7, 2011

(54) PACKAGE TRANSPORT MONITORING AND ANALYSIS

(76) Inventors: Abdul Hamid Salemizadeh, Burleson, TX (US); Robert G. Bacchus, Arlington, TX (US)

(21) Appl. No.: 12/896,037

(22) Filed: Oct. 1, 2010

Related U.S. Application Data
(60) Provisional application No. 61/247,640, filed on Oct. 1, 2009.

(51) Int. Cl. G06Q 30/00

(52) U.S. Cl. 705/333

(57) ABSTRACT

A system and method for tracking the condition of a package during transit. A method includes recording condition data for a package in transit by a test box controller in the package. The recording is performed multiple times at different locations while the package is in transit. The method includes wirelessly detecting a package tracking system at one or more of the different locations, and when the package tracking system is detected, transmitting the recorded condition data and an associated unique identifier to the package tracking system. The method includes accumulating the transmitted condition data in a server system.

### CROSS-REFERENCE TO OTHER APPLICATION

This application claims the benefit of the filing date of U.S. Provisional Patent Application 61/247,640, filed Oct. 1, 2009, which is hereby incorporated by reference.

### TECHNICAL FIELD

The present disclosure is directed, in general, to monitoring package conditions during shipment and delivery of the packages.

### BACKGROUND OF THE DISCLOSURE

Information relating to package conditions during transport is desirable, as is detecting any potential damage as soon as possible.

### SUMMARY OF THE DISCLOSURE

Various disclosed embodiments include a system and method. A method includes recording condition data for a package in transit by a test box controller in the package. The recording is performed multiple times at different locations while the package is in transit. The method includes wirelessly detecting a package tracking system at one or more of the different locations, and when the package tracking system is detected, transmitting the recorded condition data and an associated unique identifier to the package tracking system. The method includes accumulating the transmitted condition data in a server system.

Another embodiment includes a system for monitoring a box in transit. The system includes a box and a test box controller packaged in the box. The test box controller has a processor, a memory connected to the processor, a wireless communication device connected to communicate with the processor, at least one sensor device connected to be read by the processor, and a battery. The test box controller is configured to record condition data based on the at least one sensor device at multiple times at different locations while the box is in transit.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented, for example as one of the systems or servers described below, and can be configured to perform processes as described herein;

FIG. 2 is a simplified block diagram of a test box controller in accordance with disclosed embodiments;

FIG. 3 illustrates an example test package that can be used in processes in accordance with disclosed embodiments;

FIG. 4 shows a simplified block diagram of a test box controller in transit; and

FIG. 5 depicts a flowchart of a process in accordance with disclosed embodiments.

### DETAILED DESCRIPTION

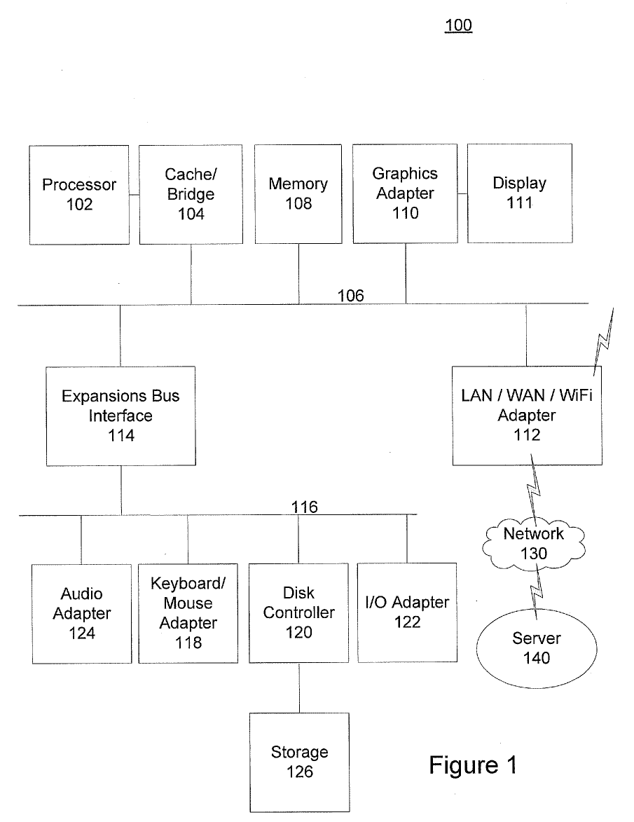

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Disclosed embodiments include a system and method for tracking the location and conditions of a package throughout the shipping process. Various conditions of the package can be tracked, such as absolute location, location within a facility, temperature data, impact and jarring data, and other data as described herein.

FIG. 1 depicts a block diagram of a data processing system in which an embodiment can be implemented, for example as one of the systems or servers described below, and can be configured to perform processes as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. I/O adapter 122 can also be connected, in some embodiments, to a barcode scanner for scanning barcode labels on test packages or test box controllers, and can be connected to communicate directly with a test box controller as described herein.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. LAN/WAN/Wireless adapter 112 can also communicate with test box controllers as described herein, and perform other data processing system or server processes described herein. Data processing system 100 can communicate over network 130 with one or more server systems 140, which are also not part of data processing system 100, but can be implemented, for example, as separate data processing systems 100.

One or more data processing systems can be implemented as package tracking systems (PTSs). PTSs can be located at the targeted hubs or terminals through which the test box may pass, and can operate independently or be connected to that facility's local area network (LAN). Each PTS can perform multiple functions, which can include preparing/configuring a test package for shipment, obtaining the data from a test package via wireless or wired connection, analyzing the data and producing reports, and performing WiFi triangulation functions to locate a test package within a facility.

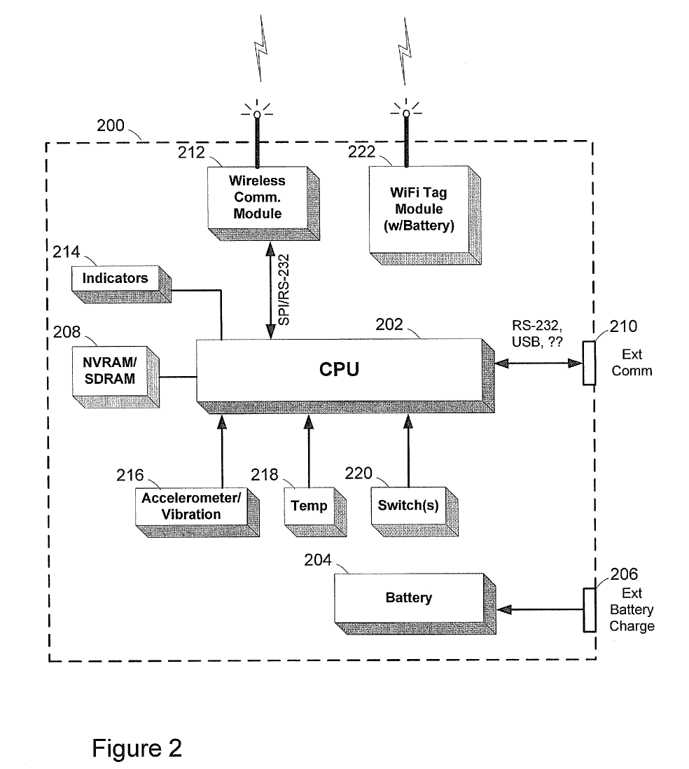

FIG. 2 is a simplified block diagram of a test box controller in accordance with disclosed embodiments.

Test box controller 200 is intended to be transported in a test package, as described in more detail below, to collect data related to the transport process, store it, and transmit it to server systems.

Test box controller 200, in this exemplary embodiment, includes a processor 202, which can be implemented using any appropriately configured microprocessor, controller, FPGA, ASIC, or other device or off-the-shelf controller configured to perform processes as described herein. Test box controller 200 can be powered by a battery 204, which can be connected to an external battery charge port 206 to be charged or to supply power from an external battery or other power source. The battery 204 is connected to power the various other components described herein, but these connections are omitted from this simplified diagram for clarity purposes. Processor 202, or memory 208 described below, can be associated with a unique identifier that identifies that test box controller and can be communicated along with other data as described herein.

Processor 202 is connected to communicate with memory 208, which can be implemented using conventional, commonly available volatile and non-volatile memory, for storing instructions and data as described herein and as necessary to support the processes described herein. A portion of memory 208 can be volatile, and another portion is preferably non-volatile for storage of collected data, particularly in case of loss of power and/or unavailability of WiFi access. The test box controller 200 can download and store configuration, calibration, and other data in memory 208 to specify the conditions for any test process. Various embodiments can use this data to produce consistent readings between various boxes so that individual calibration is not necessary.

Processor 202 is also connected to communicate with an external communications port 210. External communications port 210 can be, for example, a port such as a Universal Serial Bus serial port, or other serial, parallel, optical, or other type of communications port.

Processor 202 is also connected to communicate with a wireless communications module 212, which can be a WiFi, cellular, or other wireless communications device capable of communicating data as described herein.

Processor 202 is also connected to communicate with indicators 214, accelerometer and vibration sensor 216, temperature sensor 218, and switches 220, and can be connected to communicate with other sensors, switches, and communications devices as required. In some embodiments, processor 202 includes a clock function.

In some embodiments, the accelerometer and vibration sensor 216 includes a three-axis accelerometer sensor to track sudden changes in force or impact, such as the test box controller 200 or its box (described below) being dropped or thrown or sustaining another impact. In some cases, this can be a three-axis, +/−8 g accelerometer. The test box controller can maintain variable impact threshold values that allow for sensing and reporting flexibility. These values along with specific design calibration information can insure consistent impact sensing across various test box dimensions and weights.

Temperature sensor 216 can detect the current temperature of the test package and its ambient surroundings. Where necessary, the test package can include appropriate venting or holes to allow the temperature sensor 216 to more accurately detect the temperature. In some embodiments, the test box controller 200 can use the temperature sensor 216 to detect internal package temperature using a fast acting silicon based temperature sensor. The sensor can be located in such a manner as to minimize electronics temperature interference.

Other sensors can include a global positioning satellite (GPS) sensor for determining location data both at a facility and while in transit between facilities. Other sensors can include a three-dimensional orientation scanner that can determine the physical orientation of the test package, for example to determine if “this side up” requirements are being met. Other sensors can include a sensor capable of detecting exposure to electromagnetic fields that exceed a pre-specified level and duration, which can be important with regard to electronic devices with on-board memory. Other sensors can include a sensor capable of detecting exposure to electrostatic fields that exceed a pre-specified level and duration, which can be important with regard to any electronic device sensitive to electrostatic discharge. Other sensors can include a sensor capable of detecting moisture to which the external surface of the package has been exposed or moisture that has penetrated the package, which can be important for packages that require transit in a completely dry environment.

In various embodiments, the test box controller can output raw sensor data via a wired connection, using external communications port 210, or via a wireless connection, using wireless communications module 212, to be interpreted externally. In some embodiments, the external communications port 210 can also be used to update the firmware of the test box controller 200, which can include updating computer-executable instructions stored in a computer-readable medium such as memory 208.

Test box controller 200 also includes, in some embodiments, a locator tag 222, and appropriate independent power source or connection to battery 204. Locator tag 222 is configured to perform the location processes described below, and can be implemented, for example, using battery-powered WiFi tags such as those used as part of the EKAHAU RTLS real time location system, or any other device or tag capable of working with an indoor triangulation- or WiFi-based location detection system. Locator tag 222 can be used for WiFi triangulation technique, and can be optionally connected to the processor 202 to store location or wireless network data detected during transport.

In other embodiments, the wireless communications module 212 can be used for location purposes using WiFi triangulation techniques for package tracking and to store location or wireless network data detected during transport.

In either case, the location data can be used to interface to a WiFi triangulation system to map the location of a test package on within a facility. In some cases, a WiFi tracking infrastructure is in place at a facility, and can be used with the locator tag or wireless communications module 212. The correlation of location data can be performed external to the test box controller 200, which can help extend the battery life of the test box controller 200. The test box controller 200 can detect and record the location data as its absolute location within a facility, including its elevation with respect to the ground. The WiFi triangulation system can be implemented as part of the PTS described above.

In some embodiments, the test box controller 200 is an ultra-low-power device that has an effective battery life of three weeks per charge; in other embodiments, the battery preferably but not necessarily has a one-week effective life, which is sufficient for most shipment tracking. Various of the components described above can be implemented by common off-the-shelf parts.

Test box controller 200 can be implemented as a self-contained unit containing the components described above, or one or more of the components can be partially or wholly outside the unit, so long as they are connected to perform processes as described herein. Test box controller 200 can also optionally include basic input/output devices connected to communicate with processor 202 or other components. For example, light-emitting diodes or an LCD display can be used to indicate the state of the device or various sensors, and test box controller can include simple switches or buttons to change the state of the device. In most embodiments, however, these input/output devices are omitted to conserve both space and power in the test box controller 200.

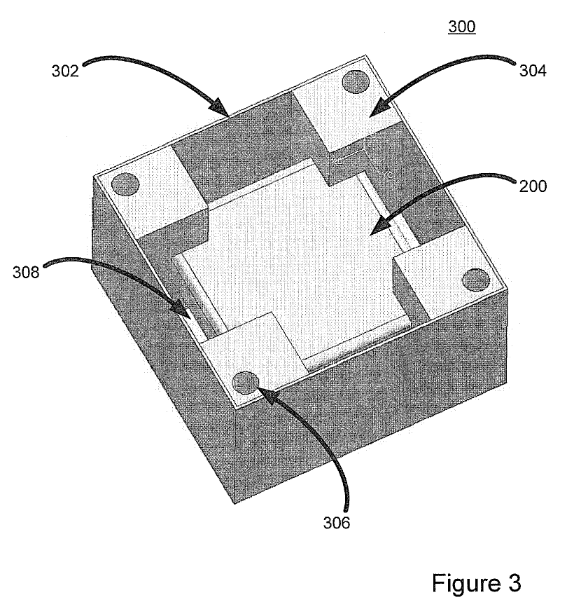

FIG. 3 illustrates an example test package 300 that can be used in processes in accordance with disclosed embodiments.

Test package 300 includes a box 302. Box 302 is preferably a generic box, so that it cannot be detected as a test package during shipment. Box 302 can be, for example, a simple cardboard box, and can be labeled with standard shipping labeling. Further, box 302 can be labeled with specific indicia, branding, or other indicators for a specific customer or user, so that it appears to be simply one more package shipped by that customer. The box 302 is sized to contain the test box controller, appropriate packing material, and any other contents desired by the customer or shipper. In this example, the box is 11″L×11″W×11″H.

In some cases, box 302 can include special internal identification or marking in case of accidental opening or damage of the test package 300, so that damage, opening, or other tampering can be detected.

Test package 300 includes a test box controller 200, such as that described above, packed inside box 302. In this example, the dimensions of the test box controller is 8″L×8″W×3″H.

Test package 300 includes packing material 304, used to pack and secure test box controller 200 inside box 302 in a manner that other contents would typically be shipped. Packing material 304 can be, for example, a styrene foam, which can act as a controlled spring-damper, or other typical packing material that can provide consistent spring/damper reaction to shock. Test box controller 200 can be used in varying sizes of the boxes 302 via custom-sized packing material 304 that create the appropriate fit between the test box controller 200 and the size of the box 302.

The packing material 304 can include holes or compartments 306. The compartments 306 can be used to add ballast to the test package 300 for extra weight, for an external battery, or otherwise.

Preferably, test box controller 200 is held by packing material 304 so that it is not in contact with any side of the box 302. In this example, there is a clearance area 308 that provides space on each side of the test box controller 200, such as 1.5″ clearance on each side of test box controller 200 and 4″ clearance at the top and bottom of test box controller 200.

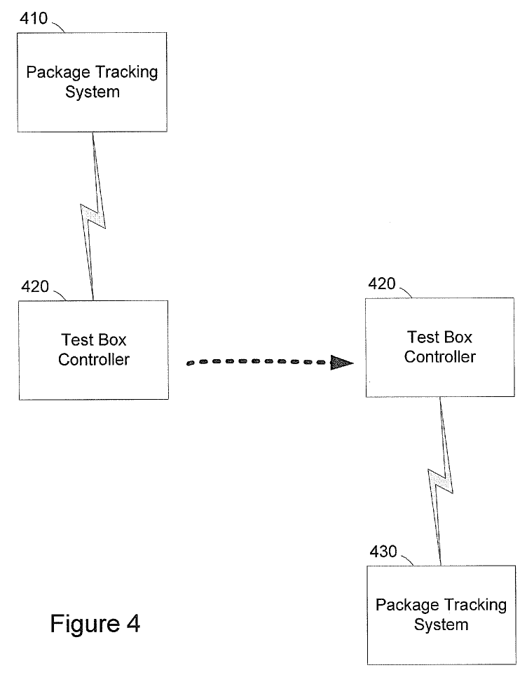

FIG. 4 shows a simplified block diagram of a test box controller 420 in transit. According to various embodiments, the test box controller 420 communicates with a first package tracking system 410 at a first location, then is transferred to a second location. At the second location, test box controller 420 communicates with a second package tracking system 430. In most cases, the test box controller will be packaged in a box so that those transporting the box do not know that there is a test box controller inside.

During transit, the test box controller continually, periodically, or sporadically records condition data and stores it in its memory, along with a timestamp indicating the time the condition data was recorded. The test box controller can monitor and record the condition data at configurable time intervals with resolutions in as low as milliseconds. Different types of condition data can be recorded at different intervals, or as triggered by other detected events. For example, temperature could be measured every X seconds or minutes; and some conditions such as impact, acceleration, and others would trigger the test box controller measure and record the event as condition data. In these cases, the test box controller can be configured to record the condition data when these events are detected, even if it is not otherwise a predetermined time for recording the condition data.

The condition data can include information related to the test box such as location, temperature, orientation, physical forces applied to the test box controller or its box including jarring, dropping, throwing, crushing, impact forces, and motion forces, and other information related to the condition of the test box controller. In various embodiments, the test box controller can detect and record condition data both in motion and at rest, and “in transit” is intended to include at least all times between when the box is placed in transit and when it is finally received at its intended destination, whether the box is actually in motion or still at any point during that time. By using accelerometer data, the test box controller can also record how long the device remains at rest each time it remains at rest, including if it is at rest longer than a pre-specified period. In this way, the test box controller can detect where delays in the shipping process may be occurring.

At each location for which the test box controller detects that a package tracking system is present, the test box controller can transmit to the package tracking system its accumulated condition data along with its unique identifier. At each location that has a WiFi signal, the test box controller can detect and record its location in the facility, or can respond to location tracking systems in the facility. In some cases, data is recorded for all the sensors of the test box controller when a change occurs from the last reading that is greater than a configurable amount.

In various embodiments, the test box controller can either “push” data to a detected package tracking system, or can respond when a package tracking system “polls” the data from the test box controller.

In various embodiments, a user can access a package tracking system to review and manipulate condition data received from a test box controller, transmit configuration or other data to the test box controller, and perform other functions with relation to the package tracking system and test box controller. In response to a user, the package tracking system can generate and display charts, reports, and graphics for condition data related to one or more test box controllers and locations, and can accumulate and analyze historical data. Reports can include charts, histograms, and statistical data, and can show condition data over time. The user can change the time scale and analyze changes over time.

Preferably, the package tracking system is secure and requires user authentication for access. Users of the package tracking system can communicate with the test box controller to configure it, such as by transmitting configuration data including the unique identifier or other tracking information, application data, clock synchronization data, download stored data, clear stored data, configure WiFi parameters, monitor test package controller battery state, and perform other functions.

The package tracking system can perform such data collection functions including receiving force and temperature measurements and other condition data, and can store this data in a database, which may be local to that package tracking system or on a remote server. The package tracking system can communicate with other servers and package tracking systems to share collected data, exchange programming, and perform other functions.

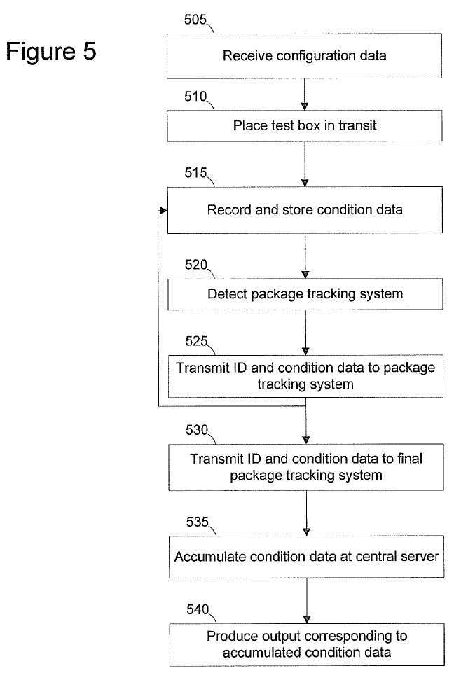

FIG. 5 depicts a flowchart of a process in accordance with disclosed embodiments.

A test box controller receives configuration data from a first data processing system (step 505). The first data processing system can be a package tracking system as described herein, a data processing system as in FIG. 1, or any other data processing system capable as functioning as described. The configuration data can include the unique identifier or other tracking information, application data, clock synchronization data, sensor threshold data, timing data for recording condition information, the time window when data are to be recorded, the minimum recording time interval, and other data as described herein.

The test box controller is placed in transit (step 510). Typically, this includes placing the test box controller into a shipping box as described above, such that the package cannot be readily discerned as containing a test box controller. This can also include applying a way bill or other shipping label with a target destination that would cause the test box controller to be routed through a specified distribution facility or segment.

The test box controller records and stores condition data as described herein (step 515), on a periodic, sporadic, or continual basis. The condition data can include location data when possible, such as when the test box controller is passing through or temporarily stored in a facility that has a WiFi signal, in which case this step includes detecting location data and storing the location data as part of the condition data using wireless network location techniques.

The test box controller detects a package tracking system at one or more facilities (step 520). This can be performed, for example, by the test box controller detecting a predefined WiFi signal or service set identifier (SSID), or otherwise. The SSID, other network information, or other information sent by the package tracking system can be used as part of the location information described herein.

The test box controller transmits its unique identifier and the stored condition data to the package tracking system at that location (step 525). This is preferably a wireless transmission that is otherwise undetectable to the personnel performing the shipping functions.

Steps 515-525 are repeated while the package is in transit (returning to step 515). Each package tracking system that receives condition data, such a first, second, and third package tracking system, can transmit the received condition data and associated unique identifiers to a central server system.

When or after the test box controller reaches its destination, it can transmit its unique identifier and the stored condition data to the package tracking system at is final location (whether that is the destination location or a processing location) (step 530).

The central server, which can be one of the package tracking systems or another data processing system, accumulates the condition data for the test box controller (step 535). The accumulated condition information describes a physical condition and treatment of the package at multiple times while the package is in transit

The central server produces an output according to the accumulated condition data (step 540), as described above.

Those skilled in the art will recognize that, for simplicity and clarity, the full structure and operation of all systems suitable for use with the present disclosure is not being depicted or described herein. Instead, only so much of the physical systems as is unique to the present disclosure or necessary for an understanding of the present disclosure is depicted and described. The remainder of the construction and operation of the systems disclosed herein may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs). In particular, computer readable mediums can include transitory and non-transitory mediums, unless otherwise limited in the claims appended hereto.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method, comprising:
recording condition data for a package in transit by a test box controller in the package, the recording performed multiple times at different locations while the package is in transit;
wirelessly detecting a package tracking system by the test box controller at one or more of the different locations;
when the package tracking system is detected, transmitting the recorded condition data and an associated unique identifier by the test box controller to the package tracking system; and
accumulating the transmitted condition data in a server system.

2. The method of claim 1, wherein the condition data includes location information for the package at one of more of the multiple times.

3. The method of claim 1, wherein the condition data includes location information that defines the location of the package within a facility at at least one of the different locations.

4. The method of claim 1, wherein the condition data includes temperature information.

5. The method of claim 1, wherein the condition data includes physical forces applied to the package.

6. The method of claim 1, wherein the condition data includes timestamps corresponding to which each portion of the data was recorded.

7. The method of claim 1, wherein the condition data is recorded when a change from previous recorded data that is more than a configurable amount.

8. The method of claim 1, wherein wirelessly detecting a package tracking system by the test box controller includes detecting a predefined wireless signal.

9. The method of claim 1, wherein the condition data includes location information determined using wireless network location techniques.

10. The method of claim 1, wherein the server system produces an output corresponding to the accumulated condition data.

11. The method of claim 1, wherein the accumulated condition information describes a physical condition and treatment of the package at multiple times while the package is in transit.

12. A system for monitoring a box in transit, comprising:
a box; and
a test box controller packaged in the box, the test box controller having
a processor,
a memory connected to the processor,
a wireless communication device connected to communicate with the processor,
at least one sensor device connected to be read by the processor, and
a battery,
wherein the test box controller is configured to record condition data based on the at least one sensor device at multiple times at different locations while the box is in transit.

13. The system of claim 12, wherein the condition data includes location information for the box at one of more of the multiple times.

14. The system of claim 12, wherein the condition data includes location information that defines the location of the box within a facility at at least one of the different locations.

15. The system of claim 12, wherein the condition data includes temperature information and the at least one sensor device includes a temperature sensor.

16. The system of claim 12, wherein the condition data includes physical forces applied to the package and the at least one sensor device includes an accelerometer.

17. The system of claim 12, wherein the condition data includes timestamps corresponding to which each portion of the data was recorded.

18. The system of claim 12, wherein the condition data is recorded when a change from previous recorded data that is more than a configurable amount.

19. The system of claim 12, wherein the test box controller is configured to wirelessly detect a package tracking system and to transmit the recorded condition data to the package tracking system.

20. The system of claim 12, wherein the condition data includes location information determined using wireless network location techniques.

21. The system of claim 12, wherein the recorded condition data is transmitted to and accumulated by a server system.
